(19) United States
(12) Patent Application Publication
(10) Pub. No.: US 2026/0172496 A1
(43) Pub. Date: Jun. 18, 2026

(54) MOBILE DEVICE ELASTOMERIC SUPPORT STRAP WITH VISIBLY IDENTIFIABLE EXPANDABLE LOGO IMPRINTS

(71) Applicant: INNOVODUCTS, LLC, Woodbridge, CT (US)

(72) Inventor: Lawrence S. Walters, Woodbridge, CT (US)

(73) Assignee: INNOVODUCTS, LLC, Woodbridge, CT (US)

(21) Appl. No.: 19/382,591

(22) Filed: Nov. 7, 2025

Related U.S. Application Data
(60) Provisional application No. 62/675,926, filed on May 24, 2018.

(51) Int. Cl. H04M 1/02; G09F 23/00

(52) U.S. Cl. CPC H04M 1/0281; G09F 23/0093

(57) ABSTRACT

A flexible, stretchable, and adjustable strap that is designed to be used with most commercially available smartphone cases to assist the user in holding and using their smartphone is provided. This strap is easily installed on and removed from such cases in minutes, without adhesive, modifications to the case, or any structure permanently attaching the strap to the case, allowing the user to use the same strap on a different case or to change straps without the need to purchase a new case. The strap, consisting of a stretchy/elastic material with hook and loop fasteners on each end that enable connection to form a loop through the existing ports on the case, is positioned to lie flat and tight against the back of the case and may be stretched from this resting position to accommodate the user's fingers, hand or other objects to steadily hold the cased smartphone. In addition to the improved functionality provided for smartphone use, the strap is designed so that logos remain visibly identifiable/recognizable and only minimally or not at all deform upon stretching the strap during use and non-use, which provides a new medium for personal expression and unprecedented promotional and advertising value to companies and organizations to connect with their customers or members and to reach potential customers and members by using the strap to identify their name, brand, message or other logo that they seek to promote.

### CROSS-REFERENCE TO RELATED APPLICATIONS

This continuation application claims priority to U.S. application Ser. No. 16/420,878, filed on May 23, 2019, which also claims the benefit of U.S. Provisional Application No. 62/675,926, filed May 24, 2018, both of which are hereby incorporated by reference herein in their entirety.

### BACKGROUND OF THE DISCLOSURE

### 1. Field of the Disclosure

The present disclosure relates to accessories for mobile devices, and particularly smartphones. More particularly, the present disclosure relates to an elastomeric support strap with a visibly identifiable/recognizable expandable logo imprint. This support strap is presented with many valuable features: (i) a thin, flexible, elastic, and comfortable structure, (ii) a quick and secure fastening system, (iii) it is adjustable and customizable, (iv) it is convenient and readily accessible for immediate use, (v) it is easy to install and remove, (vi) it improves the user's ability to hold and operate the device, and (vii) it provides a means for corporate promotion and personal expression, all of which will be immediately appreciated upon use. As used herein, the use of the terms “logo”, “logos”, or “logoed” shall mean all distinguishing markings and/or designs, in one or more colors or any combination of colors, including, all names of companies and organizations (both for profit and non-profit), brands, symbols, icons, website URLs, and any picture, pattern, drawing, illustration, expression, tagline, slogan, message, artwork, or other graphic that can be replicated on one or both sides of the strap. Such logos will allow the user a means of personal expression by displaying a design that has meaning to them. In addition, such logos will allow the corporate/organizational sponsor to access a new venue with unprecedented advertising and promotional value, and allow their supporters a means to voice support for their favorite company, brand, sports team, non-profit organization, charity, cultural, educational, historical or religious institution, mission, candidate, cause, or other passion, as they may desire.

### 2. Description of the Related Art

The use of smartphones has had an enormous impact on the way most people live in the United States and in other civilized and emerging countries around the world. Smartphone sales have been steadily increasing since their introduction with nearly 1.54 billion sold in 2017 at an estimated $478.7 billion. (https://www.statista.com/statistics/263437/global-smartphone-sales-to-end-users-since-2007/ ; https://www.statista.com/statistics/237505/global-revenue-from-smartphones-since-2008/) With over 1.80 billion smartphones estimated to be shipped in 2018, emerging markets are now taking the lead, with China and India projected to account for 37% of all shipments worldwide by 2019. (https://www.statista.com/statistics/271491/worldwide-shipments-of-smartphones-since-2009/) Smartphone users account for over 36% of the world's population in 2018, reaching a projected 2.87 billion people by 2020. (https://www.statista.com/statistics/330695/number-of-smartphone-users-worldwide/) In fact, by 2020 half of the Chinese population is projected to be using smartphones. (https://www.statista.com/statistics/330695/number-of-smartphone-users-worldwide/) With approximately 2.8 million apps available for Android devices and 2.2 million for iPhones (https://www.statista.com/statistics/276623/number-of-apps-available-in-leading-app-stores/), smartphones are now used for almost everything one would use a computer for, including news and communication, reading and education, research, entertainment, music, movies, games, retail purchases, directions, scheduling, productivity, photography, recording, etc. With this level of functionality, it is common knowledge that people check their smartphones frequently throughout the day for many different purposes. In fact, according to a 2013 Internet Trends report by Kleiner Perkins Caufield and Byers, a typical user checks their smartphone approximately 150 times a day. This report found that among other uses, people, on average, check their phones 23 times a day for messaging, 22 times for voice calls, and 18 times to learn the time. (https://www.slideshare.net/larryss/clipboards/number-of-times-per-day-that-users-check-their-phones) Another study found that people check their phones most often between 5 PM and 8 PM when more than 75% of people unlock their phones and actively use them. American adults spend 3-5 hours every day on their smartphones with social media, mobile messaging, and various apps consuming most of the time. (https://hackernoon.com/how-much-time-do-people-spend-on-their-mobile-phones-in-2017-e5f90a0b10a6). Once users check their smartphones, they often interact with it extensively. In fact, adults touch their smartphone 2,617 times per day (5,427 for the heaviest users). (https://www.networkworld.com/article/3092446/smartphones/we-touch-our-phones-2617-times-a-day-says-study.html). Many users check their smartphones habitually, with 55% of adults using their smartphone in short bursts of less than 30 seconds of activity. (https://www.huffingtonpost.com/entry/smartphone-usage-estimates_us_5637687de4b063179912dc96). 71% of Americans sleep with their smartphone on a nightstand or in their bed, and 3% hold the smartphone in their hands while sleeping. (http://fortune.com/2015/06/29/sleep-banks-smartphones/). More than half of Americans, approximately 57%, report that they use their smartphone at least once an hour and this number increases significantly in California and New York, where the statistics jump to 88% and 96%, respectively. (http://fortune.com/2015/06/29/sleep-banks-smartphones/

Some additional information regarding smartphone ownership includes: 77% of U.S. adults own a smartphone (http://www.pewresearch.org/fact-tank/2017/06/28/10-facts-about-smartphones/); 224.3 million in 2017 growing to 270.7 million by 2022 (https://www.statista.com/statistics/201182/forecast-of-smartphone-users-in-the-us/); 92% for those 18-29 year olds; 42% for those 65 and older; and 64% of lower income Americans own a smartphone (>$30,000/yr). (http://www.pewresearch.org/fact-tank/2017/06/28/10-facts-about-smartphones/) Adults use smartphones for a variety of tasks: job search-28%; dating-9%; reading an e-book-13%; shopping-51%; news alerts-55%, and 46% of adults stated that they couldn't live without a smartphone. (http://www.pewresearch.org/fact-tank/2017/06/28/10-facts-about-smartphones/). In fact, a surprising 79% of people use their smartphone for reading emails, higher than those who use it for making calls. (https://www.impactbnd.com/blog/mobile-marketing-statistics). Two other major services that will continue to grow on smartphones will be payments and messaging. By 2020, smartphones able to perform payment services will exceed 5 billion, and messaging apps will see audiences exceed 5 billion as well. (https://www.cnbc.com/2017/01/17/6-billion-smartphones-will-be-in-circulation-in-2020-ihs-report.html). From 2017 to 2020, it is estimated that the installed global base of smartphones will grow by 50% to 6.1 billion smartphone users (generating $355 billion in revenue), which is 70% of the world's population, and smartphones will account for 80% of all mobile data traffic. (https://techcrunch.com/2015/06/02/6-1b-smartphone-users-globally-by-2020-overtaking-basic-fixed-phone-subscriptions/; https://www.cnbc.com/2017/01/17/6-billion-smartphones-will-be-in-circulation-in-2020-ihs-report.html). It is also estimated that emerging markets will account for 80% of new subscriptions by 2020, which will come primarily from Asia Pacific, the Middle East, and Africa. (https://techcrunch.com/2015/06/02/6-1b-smartphone-users-globally-by-2020-overtaking-basic-fixed-phone-subscriptions/). It is additionally estimated that there will be a 59% penetration rate by 2022 with highest portions in Central & Latin America, then Asia Pacific, then Africa & the Middle East. (https://www.strategyanalytics.com/strategy-analytics/blogs/smart-phones/2016/12/21/44-of-world-population-will-own-smartphones-in-2017#.WiMjYLQ-fxr).

Although smartphones and the cases that are used to protect them are available from numerous manufacturers, across all these devices in the various ways that they are used, there exists a uniform problem common to everyone's use of them. The problem remains that people need to hold the phone in their hand, keep it steady while reading and interacting with the screen, and secure it from dropping and breaking. Although several patents have been granted and products have emerged to help users in this regard, these devices offer potential solutions that are suboptimal, as they are either permanent or semi-permanent attachments to the mobile device or its case and often include modifications to the smartphone case. Despite these aids that attempt to help users better hold and operate their smartphones, roughly 33% of people lose or break their smartphone (https://www.scripted.com/writing-samples/how-often-do-cellphone-users-accidentally-break-their-devices), with the average iPhone being broken in the first 10 weeks of ownership. (http://www.techadvisor.co.uk/feature/mobile-phone/average-iphone-broken-in-just-10-weeks-3460583/). In fact, it is reported that the top 2 ways an iPhone breaks include being dropped on a hard surface (43%) and falling into water (toilet, sink, bath, etc.) (35%) (https://www.techadvisor.co.uk/feature/mobile-phone/average-iphone-broken-in-just-10-weeks-3460583/). In 2017, 79% of smartphone users used a case. (https://www.statista.com/statistics/368627/us-protective-case-usage-among-smartphone-owners/). Notwithstanding the fact that the overwhelming majority of smartphone owners use a case, one study shows damaged iPhones cost Americans $10.7 billion since their introduction in 2007, $4.8 billion alone in 2012-2013, and all smartphones, including iPhones, cost Americans a total of $23.5 billion in repairs & replacements from 2007-2014. (https://www.squaretrade.com/press/new-study-shows-damaged-iphones-cost-americans-10.7billion-4.8b-in-the-last-two-years-alone). In addition, 60 million smartphones are lost, stolen, or damaged annually. (https://www.marketwatch.com/story/what-it-really-costs-when-you-lose-your-smartphone-2012-04-09). Furthermore, data recovery from damaged smartphones can cost anywhere from a few hundred dollars to more than $1,500 for professional services. (http://www.nbcnews.com/id/31908845/ns/technology_and_science-wireless/t/smartphone-whoops-painful-expensive/#.WinStLQ-fxo). Discussed herein is a substantial amount of data on the number of accidents with smartphones and the billions of dollars of cost incurred as a result of these accidents, and the object of the present disclosure has the potential to substantially reduce these negative consequences for potentially billions of people.

In addition to those smartphone aids mentioned above, there are several items in the prior art that require a smartphone case to be specially made to accommodate the holding apparatus, which restricts the user to only use that case, if they want that type of holding apparatus. Since smartphones frequently become items of personal expression, with phones and cases in different colors and designs, like jewelry, this type of case prevents the user from using other commercially available smartphone cases and, therefore, restricts their personal expression and preference. Other holding devices in the prior art include a strap permanently affixed to a rigid frame that is capable of being adhesively attached to the smartphone or its case. These semi-permanent attachments are claimed to be removable and re-adjustable, but would be inconvenient to do so on a frequent basis, and repeated removal and reinstallation would likely weaken the adhesive's ability to adequately secure the attachment to the smartphone/case, potentially causing accidents and costly breakage. In addition, other holding apparatuses are available that include handles, wrist straps, elastic materials with hooks that cover or overlap the edges of the phone, bulky plastic telescoping posts and tethered disks or loose loops, but all of them tend to be uncomfortable, cumbersome, inconvenient, aesthetically unattractive, and/or often get in the way of using the phone or inserting and removing it from a person's pocket or bag.

It is now becoming apparent that smartphone use can cause hand pain, especially in the thumb (https://www.today.com/health/smartphone-use-can-lead-hand-pain-t23161), since thumbs drive 75% of all phone interactions, according to a study (https://alistapart.com/article/how-we-hold-our-gadgets). As much as we use them, the fact remains that our use of smartphones is unstable, since many people (49%) use one hand (67% use their right hand) (https://alistapart.com/article/how-we-hold-our-gadgets) and mostly in the portrait mode. (https://www.uxmatters.com/mt/archives/2013/02/how-do-users-really-hold-mobile-devices.php).

Accordingly, there is a need for a device that remedies the disadvantages described above and allows users to better hold and operate their smartphones more effectively and comfortably while reducing drops, breakage, and excessive strain on the hand.

### SUMMARY

Smartphones have become so ubiquitous that people use them in conjunction with many of their other activities throughout the day and evening, including exercising and other fitness related activities, traveling, reading and multi-tasking, etc. and they require a convenient tool to help them hold and use their phones more effectively and comfortably for longer periods of time. In addition, such a means should also assist the user in holding their phone more securely and in a way that compliments and assists them with what they are doing and not interfere with it.

A flexible, stretchable, and adjustable strap that is designed to be used with most commercially available smartphone cases to assist the user in holding and using their smartphone is provided. These straps are easily interchangeable and can be installed on and removed from such cases in minutes, without adhesive, modifications to the case, or any structure permanently attaching the strap to the case, thereby allowing the user to quickly and easily change straps and put a new strap on their current case or use their current strap on a different case, without the need to purchase a new case. The strap, consisting of a stretchy/elastic material with hook and loop fasteners (e.g. Velcro), on each end that enable connection to form a loop through the existing ports on the case, is positioned to lie flat against the back of the case and may be stretched from this resting position to accommodate the user's hand, or other objects, to steadily hold the cased smartphone. An additional key feature of this strap is the ability to quickly and easily adjust the tension over time to improve the user's grip on their smartphone, providing the ability to continue to customize the fit over their long-term use and ownership of their smartphone.

The elastic strap easily installs into the open ports of the phone case and is held tightly in place by the tension created by stretching the elastic and fixing such tension in position with the hook and loop fasteners, as well as the pressure exerted by the phone once it is inserted into the case. Since most smartphones fit securely into their respective cases, this pressure fit helps to secure any movement of the strap around the case. This allows the case to hold the strap securely and allows the strap to stretch when the user inserts their hand between it and the case. Various hand-holding positions are permitted by this long flexible strap, which, with some phones, runs almost the entire length of the back of the case. Users can use their whole hand or any number of fingers in any configuration, as they find which positions are most comfortable for them. While involved in various activities, for convenience they can also temporarily hang their phone via the strap from any available post, coat hook, or other support. In addition, ample room is available to print logos on one or both sides of the strap, which logos remain visibly identifiable/recognizable and only minimally or not at all deform upon being stretched during use, providing a new venue for personal expression by users and brand promotion by companies and organizations.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a front view of three elastomeric straps of the present disclosure.

FIG. 2 is a front view of a mobile phone connected to a case that can be used with the elastomeric straps of FIG. 1.

FIG. 3 is a rear perspective view of the case of FIG. 2 disconnected from the mobile phone and disconnected from a first elastomeric strap of the elastomeric straps of FIG. 1.

FIG. 4 is a rear perspective view of the case of FIG. 2 disconnected from the mobile phone and having a first end of the first elastomeric strap of FIG. 3 through a camera port in the case.

FIG. 5 is a front perspective view of the case of FIG. 2 disconnected from the mobile phone and having a second end of the first elastomeric strap of FIG. 3 through a power port in the case.

FIG. 6 is a front perspective view of the case of FIG. 2 disconnected from the mobile phone and having the first end of the first elastomeric strap of FIG. 3 through the camera port near the top of the case and the second end of the first elastomeric strap of FIG. 3 through a power port at the bottom of the case.

FIG. 7 is a front perspective view of the case of FIG. 2 disconnected from the mobile phone and having the first end of the first elastomeric strap of FIG. 3 through the camera port in the case connected to the second end of the elastomeric strap of FIG. 3 through a power port in the case so that the case and the first elastomeric strap are connected.

FIG. 8 is a rear perspective view of the case of FIG. 2 disconnected from the mobile phone and connected to the first elastomeric strap.

FIG. 9 is a rear perspective view of the case of FIG. 2 connected to the mobile phone and connected to the first elastomeric strap.

FIG. 10 is a rear perspective view of the case of FIG. 2 connected to the mobile phone and connected to a second elastomeric strap of the elastic straps of FIG. 1 having two fingers between the case and the second elastomeric strap.

FIG. 11 is a rear perspective view of the case of FIG. 2 connected to the mobile phone and connected to a third elastomeric strap having four fingers between the case and the third elastomeric strap.

FIG. 12 is a rear perspective view of the case of FIG. 2 connected to the mobile phone and connected to the third elastomeric strap having one finger between the case and the third elastomeric strap.

FIG. 13 is a front view of another embodiment of an elastomeric strap of the present disclosure.

### DETAILED DESCRIPTION OF THE DISCLOSURE

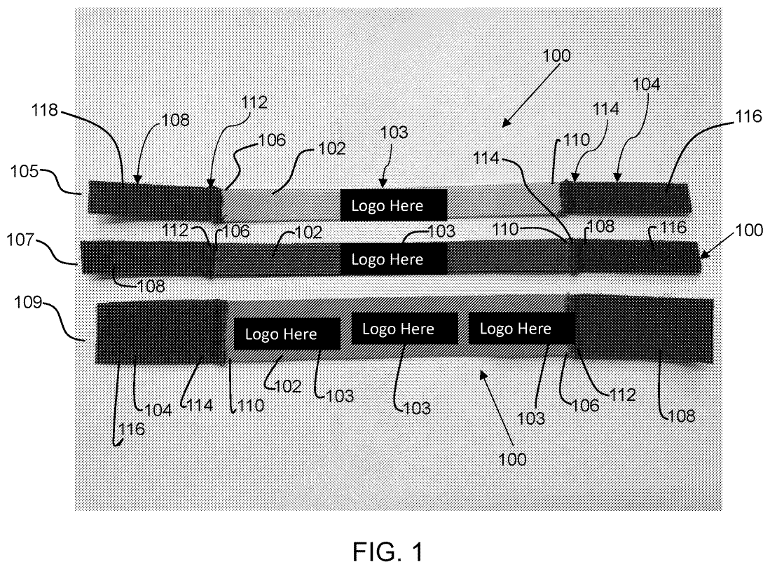

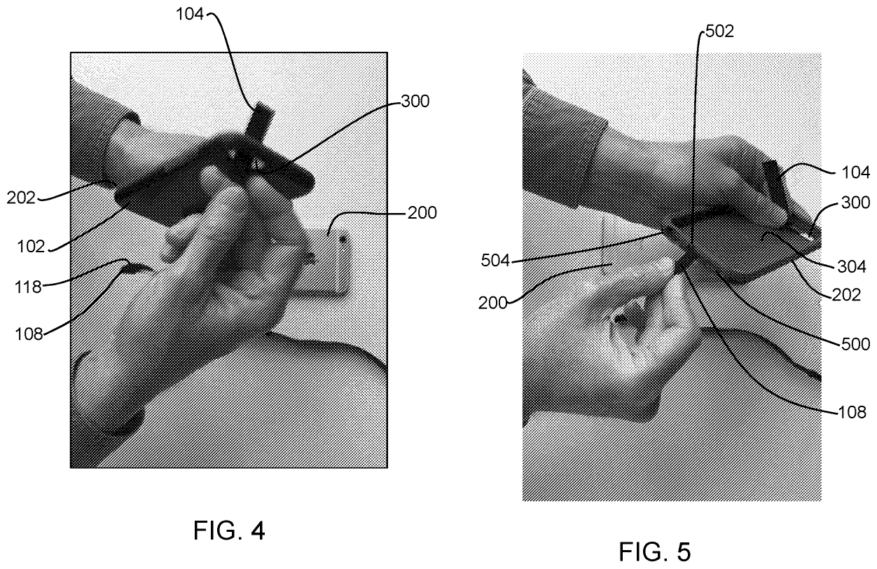

Referring to FIG. 1, three elastomeric straps 100, designated as first elastomeric strap 105, second elastomeric strap 107 and third elastomeric strap 109, of the present disclosure are shown. Elastomeric straps 100 each have a strap body 102. Strap body 102 has one or more logos 103. Logos 103 are printed on strap body 102 to minimize or eliminate deformation of logos 103 upon stretch of strap body 102. Strap body 102 has a first end 110 and a second end 106. Strap body 102 is connected to a first fastener 104 at first end 110 and a second fastener 108 at second end 106. Strap body 102 is connected to first fastener 104 and second fastener 108 by stitching 114 and 112, respectively, but could also be connected by other methods known in the art, such as glues, adhesives, staples, thermal bonding, heat sealing, etc. First fastener 104 mates with second fastener 108 by hook and loop fasteners (e.g. Velcro®) to form a loop. In addition to standard hook and loop fasteners, such as Velcro®, other adjustable fastening methods are also possible, such as the 3M Dual Lock™ reclosable fastener (preferably Low Profile), resealable adhesives, matching interlocking ridges, etc., all of which shall be encompassed herein by reference to the term “hook and loop” fastener or closure system. First fastener 104 has a first portion of the hook and loop fastener that faces a first direction on a first surface 116. Second fastener 108 has a second portion of the hook and loop fastener that faces a second direction, opposite the first direction, on a second surface 118, as shown in FIG. 4. Elastomeric straps 100 are support straps for a user's hand that fasten to the case of a mobile device, e.g., a smartphone case, (i) to reduce the tendency to drop the phone, (ii) to enable more comfortable use and effective control of the phone, (iii) to reduce hand and/or finger fatigue while using the phone, (iv) are logoed to promote the user's favorite design, brand, organization, cause or expression, which logos remain visibly identifiable/recognizable during use, (v) have a flush profile for easier phone use and storage, (vi) are made with flexible elastic material, (vii) are easily interchangeable to promote personal expression, and (viii) are an inexpensive solution to an expensive and inconvenient problem of dropping the phone. By 2020, nearly 80% of smartphone users could benefit (4.8 billion people) by use of elastomeric straps 100.

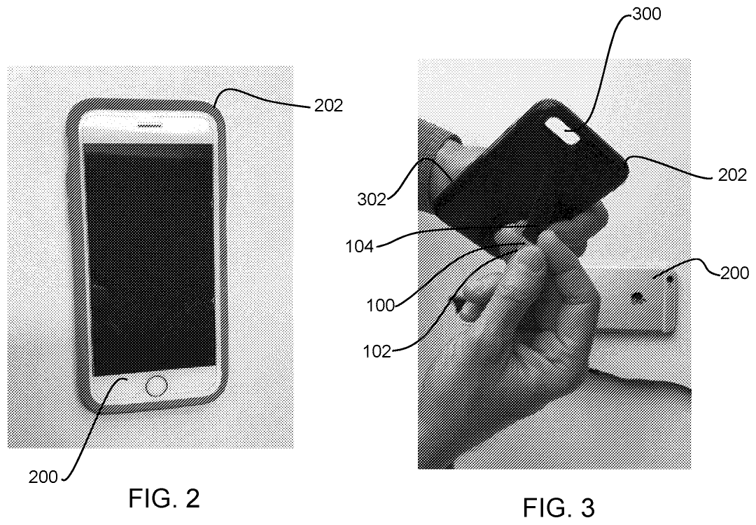

Referring to FIG. 2, elastomeric straps 100 can be used with a mobile device 200, such as a phone, shown as a smartphone, and, in particular, an iPhone® 6 smartphone, and case 202, shown as an Otterbox®. To connect elastomeric strap 100 to mobile device 200, mobile device 200 is disconnected from case 202.

Referring to FIG. 3, once mobile device 200 is disconnected from case 202, a camera port 300 in case 202 is exposed. Camera port 300 extends from an outer surface 302 to an inner surface 304, as shown in FIG. 5 that contacts mobile device 200 when case 202 is connected to mobile device 200. Camera port 300 is present in case 202 to allow a camera lens of mobile device 200 to be exposed so that mobile device 200 can take pictures while connected to case 202.

Referring to FIG. 4, first fastener 104 of first elastomeric strap 105 is passed through camera port 300 in a direction from outer surface 302 to inner surface 304 so that a portion of strap body 102 is maintained through camera port 300.

Referring to FIG. 5, case 202 has a speaker port 500, a power port 502 and a headset/microphone port 504. A portion of strap body 102 is maintained through camera port 300 while second fastener 108 is passed through power port 502 from outer surface 302 to inner surface 304 so that a portion of strap body 102 is maintained through power port 502 and another portion of strap body 102 on outer surface 302 of case 202 contacts outer surface 302. Although second fastener 108 is shown as passed through power port 502, alternatively, second fastener 108 could instead be passed through speaker port 500 or headset/microphone port 504.

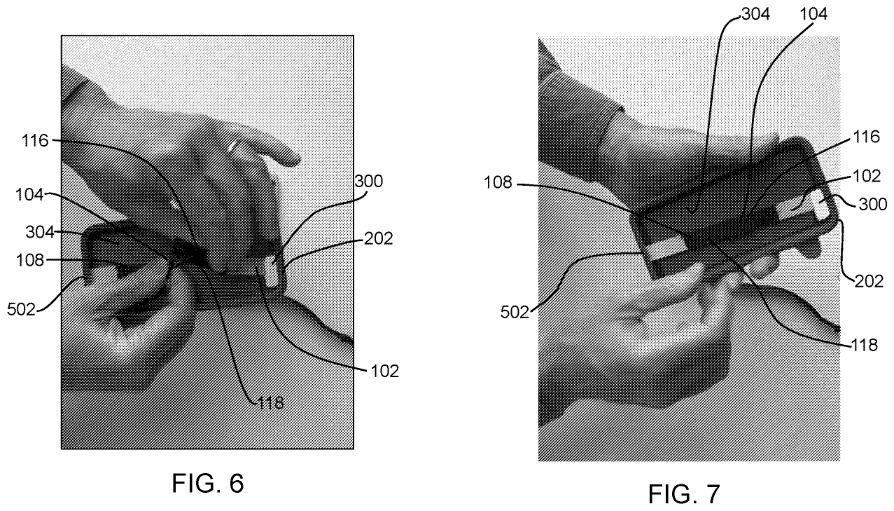

Referring to FIGS. 6 and 7, a portion of strap body 102 is maintained through camera port 300 and a portion of strap body 102 is maintained through power port 502 while first surface 116 of first fastener 104 contacts second surface 118 of second fastener 108 to connect first fastener 104 and second fastener 108 by the hook and loop fasteners to form a loop.

Referring to FIG. 8, while first fastener 104 and second fastener 108 are connected, the portion of strap body 102 on outer surface 302 of case 202 contacts outer surface 302. Alternatively, if second fastener 108 could instead be passed through speaker port 500 or headset/microphone port 504, the portion of strap body 102 on outer surface 302 of case 202 would be on a greater angle relative to camera port 300, making it very customizable and suitable for use by either the left or right hand.

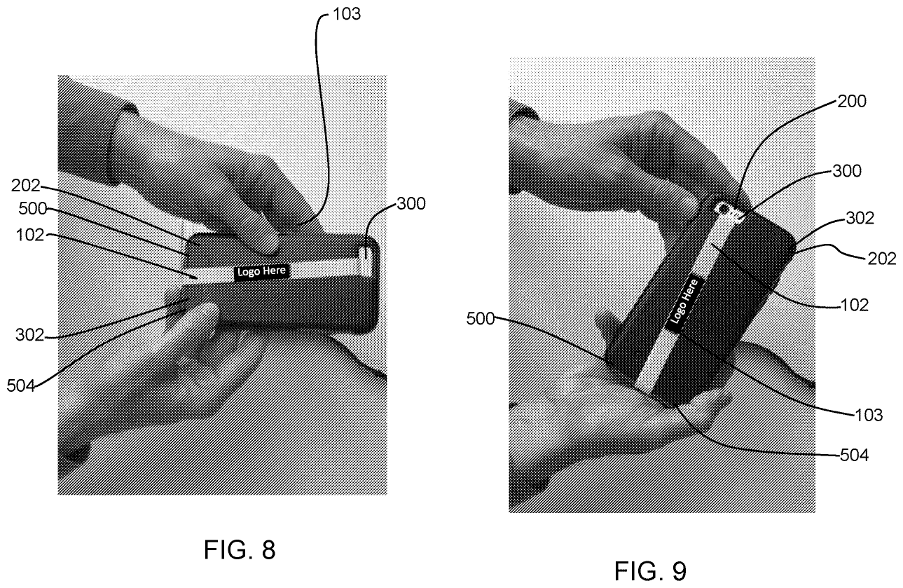

Referring to FIG. 9, while first fastener 104 and second fastener 108 are connected, mobile device 200 can be inserted into case 202 to connect mobile device 200 to case 202.

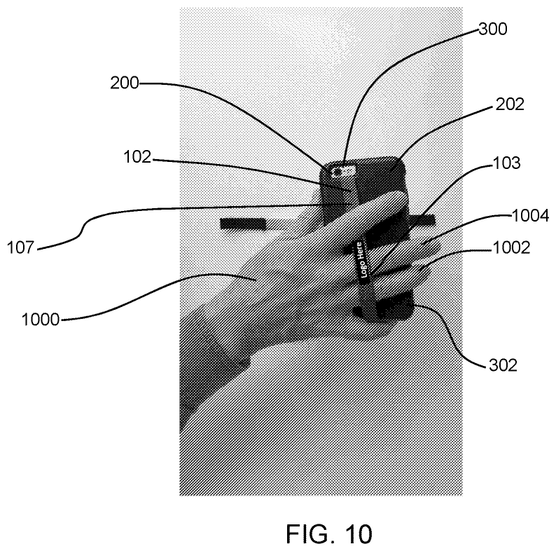

Referring to FIG. 10, elastomeric strap 107 of FIG. 1 is shown. A first user 1000 can place two fingers 1002 and 1004 between outer surface 302 of case 202 and strap body 102 of elastomeric strap 107 to hold mobile device 200 and case 202 simultaneously. Although the material of elastomeric strap body 102 stretches upon placement of two fingers 1002 and 1004 between outer surface 302 and strap body 102, logo 103 remains visibly identifiable/recognizable during use and is minimally or not at all deformed upon stretch of strap body 102.

Referring to FIG. 11, elastomeric strap 109 of FIG. 1 is shown. A second user 1001 can place four fingers 1002, 1004, 1100, and 1102 between outer surface 302 of case 202 and strap body 102 of elastomeric strap 109 to hold mobile device 200 and case 202 simultaneously. Although the material of elastic strap body 102 stretches upon placement of four fingers 1002, 1004, 1100, and 1102 between outer surface 302 and strap body 102, logo 103 remains recognizably visible during use and is minimally or not at all deformed upon stretch of strap body 102.

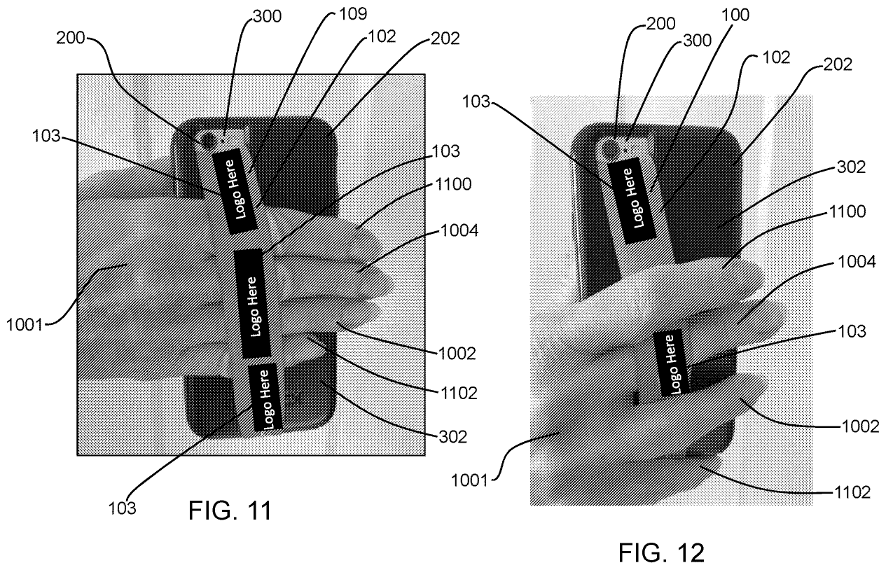

Referring to FIG. 12, second user 1001 can place one finger 1004 between outer surface 302 of case 202 and strap body 102 of elastomeric strap 109 to hold mobile device 200 and case 202 simultaneously. Although the material of elastic strap body 102 stretches upon placement of one finger 1004 between outer surface 302 and strap body 102, logo 103 remains recognizably visible and is minimally or not at all deformed upon stretch of strap body 102.

Accordingly, elastomeric strap 100 can fit many different hand and finger sizes. In addition, elastomeric strap 100 can fit most cases, not just the case shown as case 202.

The use and function of elastomeric strap 100 relies primarily on an elastomeric fabric material of strap body 102. For example, the fabric of strap body 102 is a woven elastomeric fabric. Elastic fabrics, also called flexible straps, webbings, tapes, etc., can be made in nearly an infinite number of varieties. The woven elastomeric fabric requires a flexible elastic material that stretches in the lengthwise or longitudinal direction, i.e., the “warp”, but with minimal to no stretch in the latitudinal or transverse direction, i.e., the “weft” or “woof”. These fabrics are made with an elastic material that is often comprised of spandex, rubber, or other materials that have elastomeric properties. In many cases, this elastic filament, as a core material, can be wrapped with a non-elastic material such as polyester or nylon to provide strength, durability and protection to the core elastic strand. This wrapping can be done in many ways to produce (i) single-covered elastic yarns, where a single strand of non-elastic polyester or nylon is wrapped in a single direction around the elastic spandex or rubber core, (ii) double-covered elastic yarns, where the non-elastic outer strands are wrapped in opposite directions around the elastic core, and (iii) air-covered elastic yarns through a high-speed process that entangles the elastic and non-elastic materials together to produce the elastic yarn.

In many cases, these yarns are composed of multiple layers of filaments grouped or twisted together for strength and durability and can be produced in any number of combinations, with as few as two or three filaments up to 50 filaments or more for apparel applications. A common combination for an elastic strand is often found to be 34, 36, 44, 48, and 68 (microfiber) filaments. For narrow elastic webbings, it is common to have these strands contain 34 or 36 filaments. The size of these strands or yarn is measured in “denier” with higher numbers representing increasing thicknesses. It is also common to texture the yarn to increase its volume and to instill other desired properties, such as air and vapor permeability, smoothness and a more compliant feel.

To produce an elastic fabric, the elastic material is then knit or woven in combination with other elastic and non-elastic materials such as polyester, nylon, cotton, Kevlar, rubber (natural latex), polyisoprene, Neoprene, spandex, silicone, acrylic, olefin, acetate, rayon, orlon, latex and/or other materials. The elastic yarns can be positioned in a lengthwise or longitudinal direction (warp), or in a latitudinal or transverse direction (weft or woof) with other elastic or non-elastic materials positioned in the opposite direction. These elastic fabrics can be made in a diverse combination of constituent materials and in a wide variety of styles for different applications.

Selection of the right elastic material for strap body 102 is important, as certain materials will work better with elastomeric strap 100 than others. Since the subject of elastomeric strap 100 will be used by people holding elastomeric strap 100 in and around their hands and washed from time to time, spandex is a better choice in contrast to natural rubber, as rubber does not last as long, especially when it comes into frequent contact with perspiration and chlorine, and some people are allergic to it. To gain additional desirable properties, such as water resistance, antimicrobial/antibacterial protection, etc., other treatments and materials could also be considered to improve the strap's performance and preserve its integrity and durability.

For purposes of strap body 102, many types of elastic and non-elastic materials could be used to produce a suitable fabric. However, the optimal fabric would be a smooth, flat, thin, comfortable, woven material with elastic properties in the lengthwise or longitudinal direction (warp) and with non-elastic properties in the latitudinal or transverse direction (weft or woof). A sample of one such optimal fabric was custom produced by Interstate Narrow Fabrics, Inc., with offices at 1101 Porter Avenue, Haw River, NC 27258. This material was a woven narrow elastic with a 560 denier spandex woven in the warp direction to supply stretch longitudinally, and a non-elastic 150 denier textured polyester for the filling woven in the weft or woof direction to supply strength and support without stretch laterally. A ½″ sample of this material consisted of 44 ends of 560 denier spandex that was double-covered with two single ends of non-elastic 150 denier textured polyester 36 filaments wrapped in opposite directions with one end on the top and one end on the bottom of the spandex. This elastic yarn was produced by McMichael Mills, Inc., with offices at 130 Shakey Road, Mayodan, NC 27027. This material was heat treated to generate a fuller, softer, and more comfortable feel with a desirable luster and was pre-shrunk to retain its shape and improve its suitability for printing. In the present case, dye-sublimation printing was used, although other methods known in the art could be used as well. Synthetic filament yarns work well for sublimation printing, which is important for the present disclosure, since the clarity of the printed logos, as defined earlier, to be applied to them is critical to the commercial success of the product.

To manufacture the woven elastic webbing, Interstate Narrow Fabrics, Inc. loom weaved this 560 denier spandex material, in combination with the non-elastic 150 denier textured polyester produced by Unifi, Inc., with offices at 7201 W. Friendly Ave., Greensboro, NC 27410. Although the finished elastic webbing can be woven in a wide variety of widths, this material in a ½″ width± 1/16″ was found to be an optimal width for the present disclosure. Other widths for this elastic material up to approximately 1″ could also work well. Although the specific percentages of fiber content used to produce elastic fabric can vary greatly from approximately 1%-99% for each fiber used, the sample mentioned above contained 62% spandex and 38% polyester. Likewise, although elastic fabrics can be produced with a wide range of stretch, depending upon the type and percentage of spandex, rubber, or other elastomeric materials used, the above sample had an elasticity/expansion capacity of 70%±10%. For example, a 10 inch piece of this fabric at rest could expand to a stretch limit of an additional 6 inches to 8 inches for a total stretched length of approximately 16 inches to 18 inches. In addition, strap body 102 can have a thickness of between 0.004 inches and 0.125 inches.

Although the above materials work well as strap body 102, there are other suitable materials known to those skilled in the art, and the above description of the optimal material, including the constituent components in their disclosed percentages, at the elasticity/expansion capacity and dimensions described above should not be construed as a limitation on the suitability of other materials or to narrow the scope of this disclosure to just the material disclosed above. All suitable narrow elastic materials that work in the application of the disclosure are considered to be encompassed within the present disclosure.

The ability to print on the above elastic fabrics is an important feature of elastomeric strap 100. Commercial success will depend upon the capability of these fabrics to clearly, accurately and durably receive and retain the desired logos, as described above, across various for-profit and not-for-profit industries and sectors of society.

Although printing is a well-established and highly diverse technology involving the use of paints, dies, stains, and other elements to reproduce desired content, printing on flexible, elastic materials is more challenging as certain materials such as paints, which primarily remain on top of the material, will crack with use over time and distort the printed image, especially when stretched. In the case of the present disclosure, dye-sublimation printing was found to be the optimal method for printing on narrow elastic webbing. Dye-sublimation printing works by penetrating the surface of certain materials with special inks, which then bond with certain polymers in that material, when heated, to create a permanent image. While dye-sublimation printing can be done on a wide variety of rigid and soft substrates, when it comes to fabrics, only polyesters, nylons and other synthetic materials are suitable. Sublimation inks are printed onto a specially treated sublimation transfer paper, which is then heat pressed against the fabric to transfer the inks into and permanently bond with the fabric upon cooling. This process allows the base fabrics to retain their shape and feel, while supporting printed images that will not wear or wash off. Dye-sublimation printing on narrow elastics can be especially challenging and the sample mentioned above was printed by Trans-Tex, Inc., with offices at 117 Pettaconsett Avenue, Cranston, RI 02920. The above description is not intended to limit the present disclosure, and all other similar printing processes on suitable narrow elastic fabrics are included within the present disclosure as well.

Without limiting all the many advantages to be summarized later, there are essentially 6 primary features/benefits provided by elastomeric strap 100: (i) Operability—elastomeric strap 100 improves the user's ability to better operate their phone by making it easier to access a larger portion of the smartphone's screen, while holding the phone more securely and confidently, (ii) Adjustability—elastomeric strap 100 is quickly and easily adjustable, without tools or adhesives, for a more customized and secure fit made possible by a strong and reliable hook and loop closure system, (iii) Comfortable—elastomeric strap 100 is thin, flexible, soft, and comfortable on the hand and fingers across a range of versatile positions, yet very strong to help protect the phone, (iv) Elastomeric—elastomeric strap 100 is elastic to provide tension to help the user more easily hold their phone, while reducing hand and finger fatigue, (v) Streamlined—elastomeric strap 100 has a streamlined profile, without bulky, rigid attachments, and, as a result, is pocket friendly, and (vi) Promotional—elastomeric strap 100 has the potential for unprecedented corporate/organizational promotion and personal expression.

Operability—Elastomeric strap 100 is a flexible woven elastic that allows the user to stretch, reach, twist, and place their hand in any number of needed positions to properly access different parts of the screen, especially areas that were previously difficult to reach. More rigid competitive products do not allow this level of flexibility. Most people hold and use their smartphone with their right hand and primarily try to thumb-touch all over the entire screen, as needed. This can be difficult, especially with the larger phones. In fact, Apple, Inc. tried to help with people's inability to thumb-touch the top of the screen by allowing users to double tap the home button lightly (not down all the way), causing the top of the screen to drop down about 40% for a few seconds to enable users to access the upper regions of the screen. Unfortunately, this is not an adequate solution and light double-tapping through a long period of use can quickly become annoying and increasingly difficult. The strap of the current disclosure can be used with the whole hand (either right or left) or with any number of fingers, which is important as it allows the user to find the best positions for them to better reach and use all areas of the screen. This level of flexibility is a significant advantage over competitive products, as those other products often need the same fingers to be used each time in the same basic position and this restriction limits overall use, functionality, and comfort.

Adjustability—Elastomeric strap 100 is fully adjustable, meaning that once a user installs it to case 202, elastomeric strap 100 can be easily tightened or loosened as desired for a precise fit to the user's hand or fingers. Elastomeric strap 100 works with camera port 300 and with any portal on the bottom of phone case 202, i.e., speaker port 500, power port 502, or headset/microphone port 504, to customize the fit to each user's hand, whether they primarily use their phone with their left hand or right hand. This level of adjustability seems to be completely absent from all other commercial products, yet is one of the most important features. Most other products glue/adhere to the back of the phone or case and once stuck they are semi-permanent in that position. If you do not like the position you initially affixed it to, you must peel it off and try again. It has been asserted that these products are easily removable and re-sealable, but this is cumbersome and likely weakens the adhesive's ability to continue to adhere over time, thereby lessening the security that the competitive products offer and accidents can result. Elastomeric strap 100 does not use any glue or other adhesive to firmly grip the back of a user's case and adjusts very easily, quickly, and securely. Simply remove case 202 from mobile device 200, tighten or loosen the tension by moving first fastener 104 relative to second fastener 108 to decrease or increase the size of the loop, respectively (as measured in its resting position when disconnected from case 202), and you have a new fit, which you can continue to customize, as needed, for your entire length of use and ownership. As a result, elastomeric strap 100 is easy to install, readjust, or even remove elastomeric strap 100 and put on a different elastomeric strap 100. Once attached, elastomeric strap 100 is very durable and will hold tight with the same relative level of strength and tension for a long time.

Comfortable—Elastomeric strap 100 enables users to find many comfortable positions to hold and operate mobile device 200 for hours every day, which is critical to everyone's effective use and enjoyment of these important mobile devices. The heavy use of mobile device 200 can lead to hand and finger fatigue and possible joint injury, e.g., injury of the thumb, so finding comfortable positions for use is critical. Elastomeric strap 100 is made of a thin, soft, comfortable, woven fabric that moves and flexes with the user's various hand positions as they engage with more areas of the entire screen, and, most of all, it holds the phone comfortably secure to a user's hand because of the elastic's ability to provide the needed tension. Other non-elastic competitive products lack this advantage, which is a significant drawback to their long-term use, comfort, and functionality. Elastomeric strap 100 is one of the most comfortable solutions for long-term use of mobile device 200, in contrast to products that are made of metal or hard plastic, which can make one's finger(s) sore with extended use.

Elastomeric—Elastomeric strap 100 does not contain a glued or adhesive surface to affix it to the case, as strap body 102 is not glued to the inside or the outside of the smartphone's case. Strap body 102 is a strong and secure elastic webbing, so once it is installed on case 202 it rests snugly under tension against the back of case 302 when it is not in use. In contrast, a strap body that is non-elastic makes the strap body floppy when not being used, since it must be sized with the user's hand or fingers under it before being affixed to the case. When the user's hand or fingers are removed, the strap naturally flops freely, as there is no elastic to return the strap to a snug resting position against the back of case 302. Since strap body 102 has an elastic core, it has a memory and returns to its resting position after the user's hand or fingers are removed. As a result, the elastic of strap body 102 creates a completely different product functionally. Also, from a comfort standpoint, a non-elastic strap body requires a user to exert a certain level of hand pressure to create tension to hold the phone properly or the size of the loop would need to be fairly tight, whereas the elastic of strap body 102 creates the needed tension to assist in holding the phone, effectively reducing hand and finger fatigue, and possibly, future joint injuries. This distinction is important. For example, if a loop is sized for only one or two fingers under a non-elastic strap body, then there is not sufficient room to use more fingers or even one's whole hand. Also, if another person was to borrow that phone and they had a different size hand or used a different number of fingers, they would not be able to comfortably or even effectively use that non-elastic support device. With strap body 102 being elastic, it easily stretches to accommodate one or more fingers, the user's whole hand, or someone else's hand, and its elasticity is flexible enough to quickly adjust to changing positions, such as moving from one or more fingers to the whole hand and back again, as the user experiments to find the most comfortable positions for the phone's specific use/application at any given time. This difference between the elastic nature of strap body 102 and the non-elastic nature of competitive products is significant, and users will immediately appreciate the difference in comfort and function afforded by elastic strap 102.

Streamlined—Elastomeric strap 100 has a tight, flat and streamlined profile that is pocket friendly, i.e., it does not impede the ability of mobile device 200 attached to case 202 to easily slip in and out of a user's tight pocket or bag. Unlike other competitive products, elastomeric strap 100 is not attached to a thick plastic plate that glues or adheres to the back of the phone or case, nor does it use a protruding finger ring or bulky telescoping post or disk. Not only are these competitive products not easily removable or adjustable on a frequent basis, but the plastic or metal material adds bulk to the profile of the mobile device and case and provides a catch point that often snags on the edge of certain tight clothing. This catch point makes it difficult and frustrating to easily slip a user's smartphone in and out of their pocket, especially a back pocket, which is primarily used by females for their smartphones, since many pants tailored for women, such as jeans, do not provide sufficient room in their front pockets to comfortably put their smartphone. The elastic nature of strap body 102 and the flat, streamlined hook and loop closure system of first fastener 104 and second fastener 108 provides multiple benefits, including the ability for strap body 102 to lie flat and tight against the back of case 302, making what is believed to be the most streamlined profile of any phone support on the market. As a result, the user can also put their smartphone down on a flat surface, such as a tabletop, and continue to use the phone and its many features, whereas other products cause the phone to teeter on an angle and make it very difficult, if not impossible, for the phone to securely lie flat, screen up, since their structures on the back of the case are so pronounced. In addition, the thin, flat, and smooth nature of strap body 102 in combination with its flat, streamlined hook and loop closure system permits this portion of elastomeric strap 100 to be easily sandwiched in and securely held between smartphone 200 and case 202.

Promotional—One of the best attributes of elastomeric strap 100 is the special nature of the woven stretchable and printable fabrics of elastic strap body 102 described in this disclosure, and, in particular, the ability for logos, as defined earlier, represented by logo 103, to remain visibly identifiable/recognizable and only minimally or not at all deform upon stretching strap body 102. This ability of elastic strap body 102 to be able to receive printed logos that are durable and long wearing, and to preserve the integrity of these logos during use when elastic strap body 102 is stretched, is critical to the commercial value of this innovative promotional tool for the benefit of all company/organizational sponsors, and their customers, potential customers, and members for their personal expression. Elastomeric strap 100 provides unprecedented promotional and advertising advantages by enabling the user and others nearby to be able to easily see a company's name and logo both during use, and during non-use, when the phone is lying on a table with its screen face down, which is a typical resting position for the phone to preserve privacy. Logo 103 can represent any logo, as defined earlier, that can be replicated on the strap, allowing the user a means of personal expression or to voice support for their favorite company, brand, non-profit, sports team, cause, or other passion, as they may desire. Since users check their smartphones up to 150 times per day and spend in the range of 4-5 hours per day in total on them, the back of these phone cases provides the greatest untapped real estate for personal expression, brand promotion, advertising, and messaging available anywhere. As a particular advantage to companies, elastomeric strap 100 provides the ability to have a company/organization's name, brand, website URL and/or message represented by logo 103 within arm's reach of their customers and potential customers continually throughout the day, where they can easily see, handle, and engage with logo 103. With views of a company's brand, represented by logo 103, of nearly 55,000 (150×365) potential impressions annually to the user alone, not counting many additional impressions to others in the user's circle of influence, the innovation of elastomeric strap 100 can provide an entirely new venue for brand promotion, advertising, and messaging.

Using both sides of the elastomeric strap 100 for marketing purposes further permits companies/organizational sponsors to customize their promotional message for smartphone use. Each side of the strap could have a different logo. For example, one side of the strap could have the company/organization's name and corporate logo, such as Nike® with its classic swoosh, while the reverse side could have a corporate tagline, such as Nike's “Just Do It”. This opportunity for dual branding on two different surfaces relative to back of case 202 is non-existent among competitive products on the market and it provides twice the advertising/promotional space and value versus one place for a single name or message. It provides the company/organizational sponsor the opportunity to further customize its message to consumers, delivering a more targeted promotional appeal for greater impact. Not only is this a significant advantage to the company/organizational sponsor, it allows the user the choice of how to represent the company/organization that it supports. The user could change the strap's orientation and present one side/logo versus another, and in some cases both sides/logos can be visible during periods of the same use. For example, as the user inserts their hand between strap body 102 and the back of case 202, this action, especially when there is an increased tension on the strap, might cause the strap to temporarily twist revealing the logo on the other side. Even during this rotated state, elastomeric strap 100 maintains its strength, comfort, flexibility, and functionality, and logo 103 on the reverse side of strap body 102 remains visibly identifiable/recognizable and is minimally or not at all deformed upon the stretch and twist of strap body 102. As the user removes their hand, the typical top side of the strap, which was temporarily facing in the direction of outer surface 302 on the back of case 202, will flip around to its normal position to again present the first logo. This non-digital form of smartphone advertising, and especially with its dual-logo/messaging potential, might be as or even more effective in driving customer engagement than traditional digital marketing search and app generated advertisements that are only seen by the user infrequently. This promotional potential provides a unique new venue for all companies and organizations who want to advertise their brands/logos in a place that gets frequent notice by customers, potential customers, organizational members, and those around them. Such use also permits the user to be not only a supporter of that sponsor's brand, products, services, and mission, but also an endorser, which is the highest form of recommendation most desired by companies and organizations for their products, services, and/or causes. With users checking their smartphones up to 150 times per day, used correctly, this new promotional venue provides one of the most powerful, visible, and cost-effective means of keeping a sponsor's logo, name, message, and identification in front of their customers, potential customers, and organizational members nearly all the time and could generate significantly higher levels of engagement and support from consumers/users than other forms of traditional media or digital/online advertising, where each company's advertising/logo is only seen occasionally. The opportunity is enormous since 80% of smartphone users check their smartphone within 15 minutes of waking up, and 79% of adult smartphone users have their phones with them for 22 hours a day. https://blogs.constantcontact.com/smartphone-usage-statistics/

Promotional benefits of elastomeric strap 100 to corporate/organizational sponsors include: (i) enables companies and organizations to more effectively engage with their customers, potential customers, and organizational members by having their logo, as defined earlier, continually in front of their customers, potential customers, and members up to nearly 55,000 customer impressions per year (150/day×365), and potentially reach new customers or prospective members in the users' circle of influence, (ii) provides a durable means for long-term use for logos 103 to remain visibly identifiable/recognizable and only minimally or not at all deform upon stretch of strap body 102, (iii) captures the highest value, untapped real estate for promoting brands, companies and organizations, features, benefits, and value, (iv) provides a new and innovative marketing opportunity for companies to advertise products and services and for organizations to convey their message, (v) provides constant brand visibility to increase customers' and potential customers' top-of-mind awareness to secure the brand's positioning and value in their customers' and potential customers' mind, (vi) develops a more personal connection to customers, potential customers, and members by directly associating that corporate/organizational sponsor's name with its customers', potential customers', and members' improved smartphone experience, including avoiding a potentially inconvenient and expensive accident, (vii) reduces and replaces costly and ineffective advertising and simplifies the corporate/organizational sponsor's marketing mix to achieve greater reach and effectiveness where the inexpensive cost to provide elastomeric strap 100 is greatly exceeded by the potential benefits to their customers and potential customers, (viii) provides an inexpensive means to deliver maximum promotional impact at an extremely low cost per consumer impression, and (ix) can transform customers, potential customers, and members into endorsers.

A target audience for elastomeric strap 100 is all consumers who use a smartphone with a case, especially those who predominately use one hand to operate their phone, regardless of age or geography, all users who desire a new venue for personal expression, and all products/services companies and other organizations, especially those who want maximum long-term brand visibility and engagement with their customers, potential customers, and members at the lowest cost, regardless of business, mission, or geography. In light of the comfort, flexibility, adjustability, and other functional attributes of elastomeric strap 100, young children, the elderly, and others with compromised hand strength or grip function will especially appreciate the benefits and ease of use afforded by the present disclosure.

The printable elastic nature of strap body 102 in combination with its flat, adjustable, hook and loop closure system, namely, first fastener 104 and second fastener 108, in combination, securely held between the smartphone 200 and case 202, provide the unique ability to obtain all the other benefits mentioned above, offering the user many options not afforded by other products. Only elastomeric strap 100 employs all of the features mentioned above, together and usable at the same time.

In summary, the functional benefits to users of elastomeric strap 100 include: (i) enables users to hold, control and use most cased smartphones more easily, comfortably, securely and effectively, especially with one hand, and even when combined with other activities in the user's life, such as walking, running, working out at the gym, watching videos, listening to music, talking, texting, reading, shopping, relaxing, on the go, etc., (ii) comfortable, flexible, and adjustable for short and long-term use, (iii) permits more effective control during use of all normal smartphone apps and online activities, (iv) allows greater one-handed thumb-touch use, making more areas, especially hard to reach areas of the smartphone screen, more accessible, (v) makes all typical one-handed functions and operations easier to do, especially taking photos and selfies, (vi) reduces hand and finger fatigue, (vii) can be used with any number of fingers, the whole hand or with either hand, and in any number of various hand-holding positions, (viii) convenient, and readily-available for immediate use, (ix) adjusts to different tensions and positions, (x) protects the phone by reducing the tendency to drop or lose the phone, (xi) flush profile for easier phone use and storage, namely, easy to hold during use and rests securely on flat surfaces for routine functions, ex. calculator, scrolling, etc., (xii) pocket friendly, especially with tight pockets, (xiii) flexible elastic material holds securely to the hand during use and to the case when not in use, (xiv) logoed to promote and provide a medium for personal expression and corporate/organizational branding where such logos remain visibly identifiable/recognizable and only minimally or not at all deform upon stretch of strap body 102, (xv) easily interchangeable to tailor the user's personal expression to different situations, and (xvi) provides an inexpensive solution to an expensive and inconvenient problem, namely, reducing upwards of 2 billion expensive smartphone accidents by 2020 and reducing costs for repairs and replacements costing over $3-$4 Billion annually.

Other than the subject of this present disclosure, it is believed that no other disclosure in the prior art, concepts that have been patented to date, or commercially available competitive devices designed to assist in holding and using a smartphone, offer the simultaneously combined features, advantages, and benefits of flexibility, ease of installation and removal, adjustability, comfort, convenience, adaptability, cost-savings, and opportunities for personal expression by users, along with the unprecedented marketing advantage afforded to companies and organizations in this new digital age for efficient and cost-effective branding and advertising.

In addition to the elastomeric fabrics disclosed above, additional non-fabric materials with elastomeric properties would also be suitable for use in the present disclosure. These materials could include a wide range of potential plastics, polymers, elastomers, silicone plastics, silicone rubbers, thermoplastics, thermoset plastics, thermoset elastomers (rubber) and other substances with elastomeric properties, to the extent that they can be processed and deployed in such a way as to provide elastic properties with the capability of printing logos on them that remain visibly identifiable/recognizable during use and that minimally or not at all deform upon stretching the elastomeric strap, and that such materials are suitable for wearable human use. Amorphous polymers with a glass transition temperature below room temperature could also work in the present disclosure. These above materials also may be further modified by chemical bonding, including crosslinking, to exhibit the desired elastomeric properties with the ability to print logos on them that remain visibly identifiable/recognizable during use and that minimally or not at all deform upon stretching the elastomeric strap. Common additives, such as antimicrobials, antistatics, plasticizers, pigments, UV stabilizes, fillers, and flame retardants might also be added to these above materials to obtain specific desired properties.

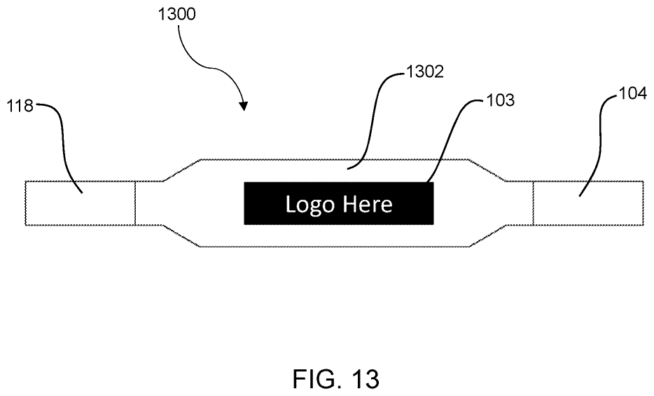

In addition to the optimal embodiment for the elastomeric strap 100 described above, other embodiments are possible and could take any number of shapes. One particular embodiment would include a non-fabric, elastomeric strap formed from one or more of the elastomeric materials described above and in a shape similar to that described in FIG. 13. The features of elastomeric strap 1300 that are the same as elastomeric strap 100 use the same reference numerals. Elastomeric strap 1300 shown in FIG. 13 is the same as elastomeric strap 100, except it includes a principal center area 1302 of a different shape than strap body 102 and is made of a different material. The principal center area 1302 would be substantially wider than the optimal embodiment described above, providing additional room for printing logos. This wider print area would be up to approximately 1 inch in width and taper down to approximately ½ inch near the ends to fit through camera port 300 and the ports at the bottom of the smartphone case. A hook and loop closure system would be fastened at each end, which are the same as or similar to first fastener 104 and second fastener 108 of elastomeric strap 100, to serve the features described earlier, including, without limitation, comfort, adjustability, quick/easy installation and removal, etc. The principle advantage of this wider elastomeric strap 1300 is the enlarged printing area for larger, more complex, and/or multiple line logos. Various manufacturing processes could be used to produce this elastomeric strap 1300, fabricated from the non-fabric elastomeric materials described above, including molding, extrusion, punching, pressing, or stamping out of large sheets of material, etc. Alternatively, with elastomeric strap 1300, a hook and loop closure system might be formed into each end as part of the manufacturing process depending on the material used and the method of manufacture.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. An elastomeric strap connectable to a case of a mobile device comprising:
a strap body having a logo, the logo being printed on the strap body to minimize or eliminate deformation of the logo upon stretch of the strap body so that the logo remains visibly identifiable or recognizable during use and non-use, the strap body having a first end and a second end that is opposite to the first end;
a first fastener connected to the strap body at the first end; and
a second fastener connected to the strap body at the second end, the first fastener mates with the second fastener to form a loop around the case of the mobile device.

2. The elastomeric strap of claim 1, wherein the first fastener mates with the second fastener by hook and loop fasteners and has a first portion of the hook and loop fastener that faces a first direction on a first surface and the second fastener has a second portion of the hook and loop fastener that faces a second direction opposite the first direction on a second surface.

3. The elastomeric strap of claim 1, wherein the logo is a first logo and further comprising a second logo, wherein the first logo is on a first side of the strap body and the second logo is on a second side of the strap body opposite the first side and such logos can be the same or different.

4. The elastomeric strap of claim 1, wherein the strap body is made of a material that is a woven elastomeric fabric having a flexible elastic material that stretches in the lengthwise direction and with minimal to no stretch in the latitudinal direction.

5. The elastomeric strap of claim 1, wherein the strap body is made of a material that has elastomeric material having spandex that is double-covered with a non-elastic material.

6. The elastomeric strap of claim 1, wherein the strap body has a portion with a width of up to 1 inch.

7. The elastomeric strap of claim 1, wherein the strap body is made of a fabric where a length of a 10 inch piece of the fabric at rest could expand to an approximate expansion capacity of an additional 6 inches to 8 inches for a total stretched length of approximately 16 inches to 18 inches.

8. The elastomeric strap of claim 1, wherein the strap body is made of a fabric comprising synthetic filament yarns or a fabric that is heat treated and pre-shrunk to retain shape and improve suitability for printing, and wherein the logo is applied to the strap body by dye-sublimation printing.

9. An elastomeric strap connectable to a case of a mobile device comprising:
a strap body having a first end and a second end that is opposite to the first end, the strap body being stretchable;
a first fastener connected to strap body at the first end; and
a second fastener connected to strap body at the second end, the first fastener mates with the second fastener to form a loop around the case of the mobile device, the first fastener is connectable with the second fastener in different positions to adjust the tension of the loop around the case of the mobile device.

10. The elastomeric strap of claim 9, wherein the first fastener mates with the second fastener by a hook and loop closure system, and wherein the elastomeric strap is free of adhesives affixing it to the case of the mobile device.

11. The elastomeric strap of claim 9, wherein the elastomeric strap is a first elastomeric strap and further comprising a second elastomeric strap, and wherein the first elastomeric strap and the second elastomeric strap are interchangeable on the case of the mobile device.

12. The elastomeric strap of claim 9, wherein the elastomeric strap connects to the case of the mobile device so that a portion of the strap body is on an outer surface of the case of the mobile device to be accessible for use, wherein the first end of the strap body passes through a first port at or near the top of the case of the mobile device and a second end passes through a second port at the bottom of the case of the mobile device, and wherein the elastomeric strap is configured to allow a user to hold, use and operate the mobile device.

13. The elastomeric strap of claim 9, wherein the strap body has a logo on an outer surface that is visible when the strap body is connected to the case of the mobile device.

14. The elastomeric strap of claim 9, wherein the strap body is held in place on the case of the mobile device by tension created by stretching the strap body and fixing such tension in position when the first fastener mates with the second fastener, wherein the strap body is stretchable to place a portion of a hand between the strap body and the case of the mobile device, and wherein the strap body is further stretchable to permit various hand-holding positions selected from the group comprising a whole hand, either hand, one or more fingers, and/or any combination thereof.

15. The elastomeric strap of claim 9, wherein the strap body has a thickness of between 0.004 inches and 0.125 inches.

16. The elastomeric strap of claim 14, wherein the logo is a first logo and further comprising a second logo, wherein the first logo is on a first side of the strap body and the second logo is on a second side of the strap body opposite the first side.

17. The elastomeric strap of claim 9, wherein the strap body is made of a material that is a woven elastomeric fabric having a flexible elastic material that stretches in the lengthwise direction and with minimal to no stretch in the latitudinal direction.

18. The elastomeric strap of claim 9, wherein the strap body is made of a material that has elastomeric material having spandex that is double-covered with a non-elastic material.

19. The elastomeric strap of claim 9, wherein the strap body has a portion with a width of up to 1 inch.

20. The elastomeric strap of claim 9, wherein the strap body is made of a fabric where a length of a 10 inch piece of the fabric at rest could expand to an approximate expansion capacity of an additional 6 inches to 8 inches for a total stretched length of approximately 16 inches to 18 inches.

21. The elastomeric strap of claim 9, wherein the strap body is made of a fabric comprising synthetic filament yarns or a fabric that is heat treated and pre-shrunk to retain shape and improve suitability for printing, and wherein the logo is applied to the strap body by dye-sublimation printing.
